(19) United States
(12) Patent Application Publication
(10) Pub. No.: US 2014/0337239 A1
(43) Pub. Date: Nov. 13, 2014

(54) METHOD AND SYSTEM FOR OBTAINING OFFERS FROM SELLERS USING PRIVACY-PRESERVING VERIFIABLE STATEMENTS

(71) Applicant: Pitney Bowes Inc., Stamford, CT (US)

(72) Inventors: YASSIR NAWAZ, Shelton, CT (US); Femi Olumofin, Trumbull, CT (US)

(73) Assignee: Pitney Bowes Inc., Stamford, CT (US)

(21) Appl. No.: 13/892,411

(22) Filed: May 13, 2013

(51) Int. Cl. G06Q 50/26; G06Q 30/06

(52) U.S. Cl. CPC G06Q 50/265; G06Q 30/0609
USPC 705/75

(57) ABSTRACT

A system and methods that preserve the privacy of personal information of consumers as they seek to take advantage of offers advertised by sellers is provided. A seller can advertise services or benefits with some criteria prospective consumers must satisfy to qualify for such services or benefits. A consumer can make a statement that shows that he or she satisfies the criteria. The requesting party is able to verify the correctness of the statement without being able to learn any additional information about the value of the attributes contained in the statement, other than the information directly implied by the statement. A consumer can be enrolled for the benefit or service after a statement has been successfully verified.

### FIELD OF THE INVENTION

The present invention relates to personal information privacy and advertising offers, and in particular to a method and system for obtaining offers from sellers using privacy-preserving verifiable statements.

### BACKGROUND OF THE INVENTION

In many instances, the type of an offer made by a seller for a service or benefit to a prospective consumer is based on the prospective consumer meeting certain criteria established by the seller. Such criteria could include, for example, a minimum income or bank account balance, employment at a particular company, a contract with a competitor of the seller for some minimum monthly amount, a minimum age etc. Before the seller will provide an offer, the prospective consumer must provide personal information to show that he meets the criteria set by the seller. Currently, prospective consumers must surrender a copy of their current bill or bank account statement, or disclose their age, email address or other personal information to prove that they qualify for the service or benefit. Consider an employee making a statement to a service provider to verify employment with a particular organization for the purpose of an employee discount. Brick and mortar service providers would typically ask for some identification, e.g. driver's license or the like, and/or business card before enrolling the employee for the discount. Online service providers typically require customers to submit their corporate email addresses on a website. In all of the above cases, there is a potential loss of privacy because of disclosure of personal information.

### SUMMARY OF THE INVENTION

The present invention alleviates the problems described above by providing a system and methods that preserve the privacy of personal information of consumers as they seek to take advantage of offers advertised by sellers or as they search for offers themselves. Even though the privacy of the personal information of a consumer is preserved, the provider of the offer (seller) is able to verify that the consumer meets some criteria without having to obtain personal information of the consumer other than that implied by the statement. The present invention considers an application where a requesting party (e.g., a seller) can advertise services or benefits (i.e., offers) with some criteria prospective consumers must satisfy to qualify for such services or benefits. A consumer can make a statement that shows that he or she satisfies the criteria. The requesting party is able to verify the correctness of the statement without being able to learn any additional information about the value of the attributes contained in the statement, other than the information directly implied by the statement. A consumer can be enrolled for the benefit or service after a statement has been successfully verified. Similarly, a consumer may create a statement involving some attribute and use the statement to search for offers. Sellers can evaluate the statement and potentially make offers without learning any additional information about the values of the attributes.

In accordance with embodiments of the present invention, a trusted third party receives information, in encrypted form, about consumers from a current service provider of the consumer. For example, the trusted third party can receive statements, e.g., current bills, bank statements, etc., that are normally sent from a service provider, e.g. utility company, bank, etc. to a consumer. The information is encrypted using predicate/searchable/functional encryption, which allows the cloud provider to determine and verify a statement about the encrypted information without learning the actual information. The consumer creates a statement about some criteria to be met, e.g., current utility bill is greater than X dollars, and a predicate/search token that can verify the corresponding statement. The consumer then sends this statement and token to the trusted third party. The trusted third party runs the predicate/search token on the consumer's encrypted information to determine if the statement is true. If the statement is true, the trusted third party digitally signs the statement to be true and sends it back to the consumer. The consumer can use this signed statement to obtain offers from sellers. The seller verifies the signature on the statement and upon verification, knows that the statement is true. An offer can then be extended to the consumer based on meeting the criteria.

In accordance with other embodiments, a trusted third party receives information, in encrypted form, about consumers from a current service provider of the consumer. For example, the trusted third party can receive statements, e.g., current bills, bank statements, etc., that are normally sent from a service provider, e.g. utility company, bank, etc. to a consumer. The information is encrypted using predicate/searchable/functional encryption, which allows the trusted third party to determine and verify an attribute of the encrypted information without learning the actual information. The consumer creates search tokens for some predetermined subset of the encrypted data that the consumer wishes for the trusted third party to use to create a credential. This is analogous to the consumer indicating the information that the consumer would like to appear on an identification document for the consumer, e.g., current telephone bill is greater than X dollars, bank account balance is greater than Y dollars, etc. The trusted third party runs the predicate/search tokens on the consumer's encrypted data and retrieves the requested information. The trusted third party does not learn anything about the customer beyond the requested information. The trusted third party subsequently encodes the information into a credential and sends it back to the consumer, and the consumer can store the credential. Whenever the consumer needs to prove compliance with some criteria to be able to take advantage of an offer or search for new offers based on meeting some predetermined criteria, the consumer can use this credential to prove qualification for such offers.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a block diagram of a system for obtaining offers from sellers using privacy-preserving verifiable statements according to embodiments of the present invention;

FIG. 2 is a flowchart of a method for obtaining offers from sellers using privacy-preserving verifiable statements that may be implemented in the system shown in FIG. 1 according to an embodiment of the present invention; and

FIG. 3 is a flowchart of a method for obtaining offers from sellers using privacy-preserving verifiable statements that may be implemented in the system shown in FIG. 1 according to another embodiment of the present invention.

### DETAILED DESCRIPTION OF THE PRESENT INVENTION

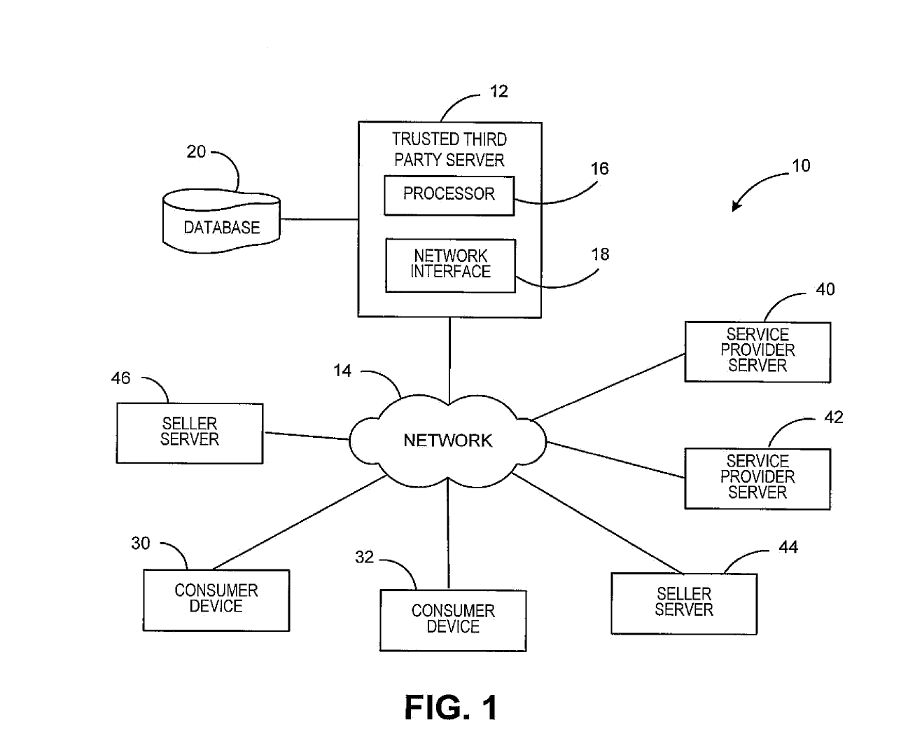

In describing the present invention, reference is made to the drawings, wherein there is seen in FIG. 1 in block diagram form a portion of a system 10 that can be used to obtain offers from sellers using privacy-preserving verifiable statements according to embodiments of the present invention. System 10 includes a server 12 operated by a trusted third party, which may be, for example, a cloud service provider, that is coupled to a network 14, such as, for example the Internet. Server 12 may be a mainframe or the like that includes at least one processing device 16. Server 12 may be specially constructed for the required purposes, or it may comprise a general purpose computer selectively activated or reconfigured by a computer program (described further below) stored therein. Such a computer program may alternatively be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, which are executable by the processing device 16. One of ordinary skill in the art would be familiar with the general components of a computing system upon which the method of the present invention may be performed. A network interface 18 is provided to allow the server 12 to communicate with other devices via the network 14.

Such other devices can include one or more consumer computing devices 30, 32, one or more service provider servers 40, 42 and one or more seller servers 44, 46. Consumer computing devices 30, 32 can include personal computers, tablets, smartphones or any other type of electronic device that has network capability and can allow a consumer to access the third party server 12 via the network 14. The consumers are interested in making statements that can be verified in cooperation with the trusted third party that operates the third party server 12. It should be understood that while two devices 30, 32 are illustrated in FIG. 1, there is no limit to the number of devices and/or users of such devices (consumers). Each of the service provider servers 40, 42 and seller servers 44, 46 can be similar to the server 12 as described above. A service provider can be any type of service provider or business that can generate information about a consumer, such as, for example, a utility company, bank, or any other entity that has information about a consumer. The information about a consumer may include, without limitation, certain demographic and/or financial information about a consumer, such as, for example, utility bills, bank account statements, other information relating to income, credit history, address, age, email address, and the like. Such information may be referred to herein collectively as personal information. A seller can be any type of service provider, business, merchant or third party acting on behalf of such entities that directly or indirectly sells products or services to consumers. The sellers desire to obtain new customers (consumers) by advertising offers with some criteria attached that must be met by a consumer to take advantage of the offer. It should be understood that while two merchants 40, 42 and two sellers 44, 46 are illustrated in FIG. 1, there is no limit to the number merchants 40, 42 or sellers 44, 46.

System 10 also includes a database 20 that is in electronic communication with the server 12. Database 20 securely stores the personal information provided by the service provider servers 40, 42 about the consumers.

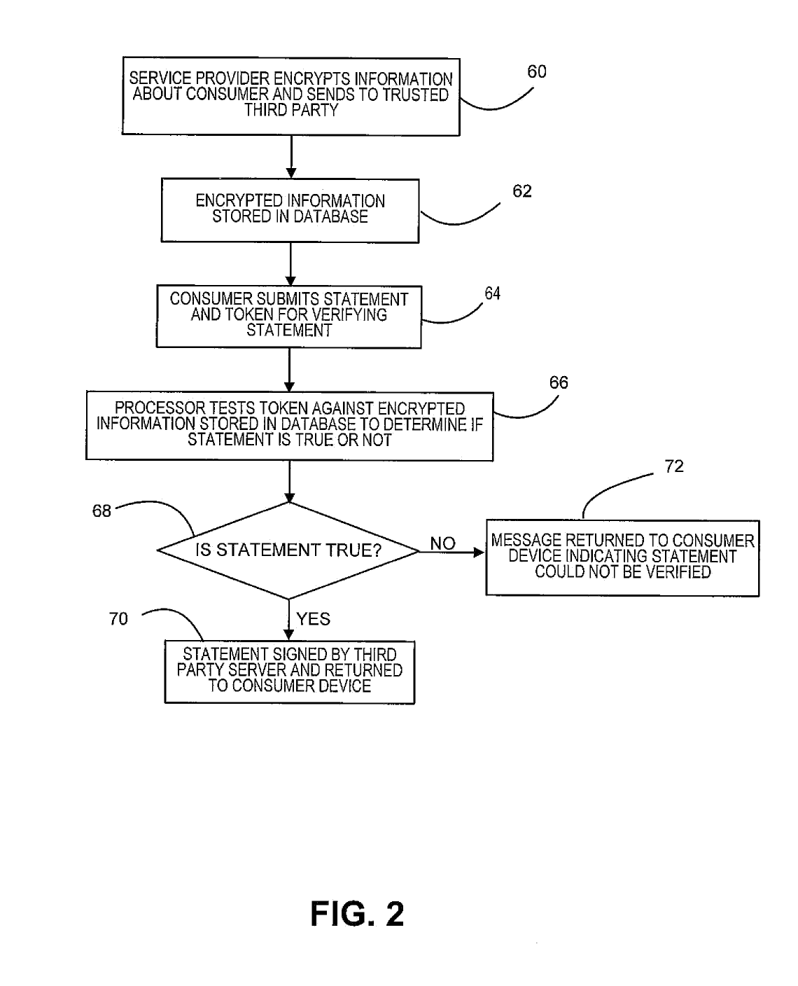

FIG. 2 is a flowchart that illustrates an example of the operation of the system 10 shown in FIG. 1 according to an embodiment of the present invention. Generally, consumers want to make statements about their personal information to sellers to obtain offers from sellers or to show they meet the criteria for some offers advertised by a seller, while desiring to keep the actual personal information private from the seller. Sellers want to ensure that these statements are true before they enroll the consumer for the offer (e.g., offer a comparable service with a lower monthly payment, or give a one-time coupon). The system 10 allows consumers to preserve the privacy of their personal information as they seek to take advantage of offers advertised by service providers or as they search for offers themselves that have some criteria attached.

In step 60, a service provider server, e.g. server 40, encrypts information about a consumer using predicate/searchable/functional encryption and sends, via, for example, network 14, the encrypted information to a trusted third party, e.g., server 12. Such information could include, for example, the consumer's current bill, statement, etc. for services that the service provider currently provides to the consumer. Predicate encryption provides fine-grained control over access to encrypted information. In traditional encryption only the holder of the secret/private key can access the encrypted information. However, in many situations it is desirable for a third party to learn some attribute of encrypted data without having complete access to it. For example an email server handling encrypted emails might need the ability to check if the subject of the encrypted email has the word “URGENT” in it for making routing decisions. Predicate encryption can enable the email server to check for this word without learning anything about the subject or content of the encrypted email. There are several known predicate encryption schemes that can be used in accordance with the present invention. An example of such a scheme is as follows. A public key predicate encryption scheme consists of four algorithms: Setup, Encrypt, GenerateToken, and TestPredicate. A user uses the Setup algorithm to generate a master secret key and a corresponding public key and publishes the public key. The service provider uses the user's public key and Encrypt algorithm to encrypt information for the user. The encrypted information is sent to the user via a third party. If the user wants the third party to check for some attribute in the encrypted information, it creates a predicate token using its master secret key and GenerateToken algorithm. The predicate token corresponds to the attribute that user wants the third party to check (presence of a keyword, greater than or less than attributes of an amount, etc.). The user gives the predicate token to the third party. The third party uses the TestPredicate algorithm (which takes the predicate token and encrypted information as input) to test the desired attribute. The output of the TestPredicate algorithm will be true if the predicate that corresponds to the token is true, i.e., the attribute that corresponds to the token is present in the encrypted document. The output of the TestPredicate algorithm will be false if the predicate that corresponds to the token is false, i.e., the attribute that corresponds to the token is not present in the encrypted document.

Returning again to FIG. 2, in step 62 the encrypted information is associated with the consumer and stored by the third party server 12 in the database 20. Because the information is encrypted, the information is kept secure and the third party does not have access to the information in plain text form. In step 64, the consumer, using a consumer device, e.g. device 30, creates one or more statements related to the information stored in the database 20 and a corresponding predicate/search token(s) that can be used to verify the statement(s) and submits them to the third party server 12. Such a statement includes some attribute about the consumer's information that the consumer wishes to have verified, without revealing the actual information itself. For example, the statement could be “My cable bill is greater than $100 per month,” or “My savings account balance is greater than $10,000.” Thus, while each of these statements may reveal some attribute about the consumer, the first statement does not reveal the actual amount of the consumer's cable bill, and the second statement does not reveal the actual amount in the consumer's savings account. It should be understood that the above statements are merely examples of such statements, and that a statement can be created by the consumer for any type of attribute based on the information stored in the database 20. For example, such attributes can include the state, city or town or residence, date of birth, income, account balances, monthly payments being made for services, etc.

In step 66, the processer 16 of the server 12 retrieves the user's encrypted information, stored in the database 20, and tests the predicate/search token received from the consumer device 30 against the encrypted information about the consumer to determine if the statement is true. This can be performed, for example, utilizing the predicate encryption's TestPredicate algorithm, which as described above will indicate whether the attribute is present in the encrypted information or not. A positive result from the test indicates that the attribute on which the token is based is present in the encrypted information, and thus the statement on which the token is based is true, while a negative result indicates that the attribute on which the token is based is not present in the encrypted information, and thus the statement associated with the token is not true. Thus, for example, if the information stored in the database 20 includes a current cable bill for $200, and the statement and corresponding token created by the consumer is “My cable bill is greater than $100 per month,” the result will be positive, and thus the statement will be verified, i.e., deemed to be true. In step 68, the processor 16 determines if the statement is true or not based on the result of the test from step 66. If the statement is true, then in step 70 the third party server 12 provides a digital signature for the statement and returns the statement to the consumer device 30, or alternatively, to a seller server 44. The consumer can now use this signed statement as proof that some criteria is met, e.g., cable bill is greater than $100, to obtain offers from sellers, e.g., seller 44. If the signed statement is returned to the consumer device 30, the consumer can submit the signed statement from the consumer device 30 to the seller server 44. The seller server 44 can verify the digital signature provided by the server 12 using standard digital signature verification techniques, thereby verifying the statement contained therein. If in step 68 it is determined that the statement is not true or could not be verified, then in step 72 a message will be returned to the consumer device 30 that indicates the statement is not true or could not be verified based on the information stored in the database 20.

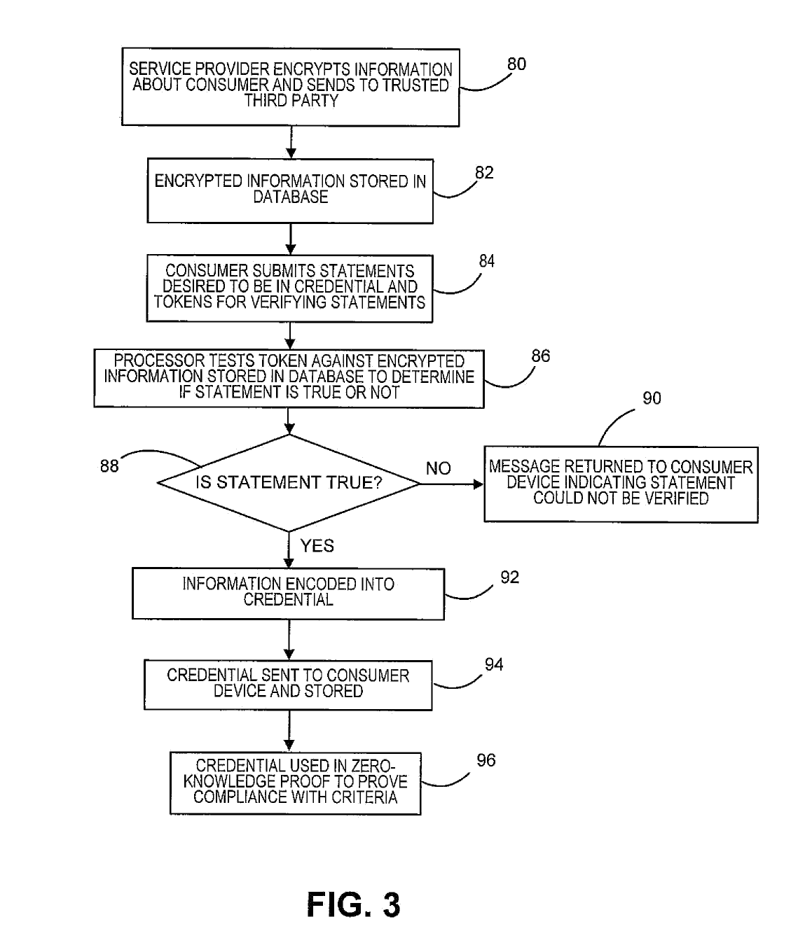

Using the process as illustrated in FIG. 2, a consumer can maintain the privacy of his personal information while still being able to prove compliance with some criteria to take advantage of an offer from a seller. However, there is still some information that is provided to a seller, e.g., the consumer's cable bill is greater than $100. Over time, the seller can link several statements provided by a particular consumer from different interactions together, and thus in some respects start to piece together personal information about the consumer. To prevent such a situation from occurring, it may be desirable to further limit the information that a seller can learn about a consumer, while still enabling the consumer to prove compliance with some criteria set by the seller to participate in an offer. FIG. 3 illustrates in flow chart form an example of the operation of the system 10 shown in FIG. 1 according to another embodiment of the present invention in which anonymous credentials are used to further protect the personal information of a consumer.

Referring now to FIG. 3, in step 80 a service provider server, e.g. server 40, encrypts information about a consumer using predicate/searchable/functional encryption, as described above with respect to FIG. 2, and sends, via, for example, network 14, the encrypted information to a trusted third party, e.g., server 12. Such information could include, for example, the consumer's current bill, statement, etc. for services that the service provider currently provides to the consumer. In step 82, the encrypted information is associated with the consumer and stored by the third party server 12 in the database 20. Because the information is encrypted, the information is kept secure and the third party does not have access to the information in plain text form. In step 84, the consumer, using a consumer device, e.g. device 30, creates one or more statements related to the information stored in the database 20 and a corresponding predicate/search token(s) that can be used to verify the statement(s) and submits them to the third party server 12. This is analogous to the consumer indicating the information that the consumer would like to appear on an identification document for the consumer, e.g., current telephone bill is greater than X dollars, bank account balance is greater than Y dollars, etc. In step 86, the processer 16 of the server 12 retrieves the user's encrypted information, stored in the database 20, and tests each of predicate/search tokens received from the consumer device 30 against the encrypted information about the consumer to determine if the statement is true or not. This can be performed, for example, utilizing the predicate encryption's TestPredicate algorithm. A positive result from the test indicates that the token, and thus the statement on which the token is based, is true, while a negative result indicates that the token, and thus the statement associated with the token, is not true. Thus, for example, if the information stored in the database 20 includes a current cable bill for $200, and the statement and corresponding token created by the consumer is “My cable bill is greater than $100 per month,” the result will be positive, and thus the statement will be verified, i.e., deemed to be true.

In step 88, the processor 16 determines if each of the statements is true or not based on the result from the test of step 86. If it is determined that a statement is not true or could not be verified, then in step 90 a message will be returned to the consumer device 30 that indicates the statement is not true or could not be verified based on the information stored in the database 20. If in step 88 it is determined that a statement is true, then in step 92 the third party server 12 encodes the information into a credential. It should be understood that more than one statement can be encoded into a single credential. This cryptographically encoded credential allows for selective disclosure of the information retrieved from the encrypted statement. Preferably, the credential is an anonymous credential, in which the user has several disclosure options: disclose all information, disclose select attributes, disclose result of expressions involving select attributes (e.g., bill amount≧100) or disclose nothing. When a consumer selectively discloses information from her credential, the seller will not be able to learn about the other attributes in her credential. The server 12 uses an appropriate credential issuing protocol to encode the retrieved information into the credential. It should be noted that the encoding of the credential can typically be performed in an interactive process between the server 12 and consumer device 30. However, since the server 12 is in possession of the information that needs to be encoded, it performs the encoding using appropriate credential issuing techniques, such as, for example, those of Brands, or Carmenisch and Lysyanskaya (CL signatures), etc. For example, the extracted attributes of information x₁, x₂, . . . , xₙ can be encoded as credential h=g₁^{x1}·g₂^{x2}· . . . ·gₙ^{xn}, Sig_{{server 12}}(h), where g₁, g₂, . . . , gₙ, are generators of a group of prime order p, we let Zₚ={0, . . . , p−1} and Sig_{{server 12}} is a signature using the secret signing key of server 12. In step 94, the credential is sent to the consumer device 30, and stored in a memory device of the consumer device 30.

Whenever the consumer needs to prove qualification with some criteria set by a seller to take advantage of an offer, then in step 96 the consumer can retrieve the credential from the memory of the consumer device 30 and provide it to the seller, e.g., seller server 44. The consumer will engage in a zero-knowledge proof with the seller server 44 using the credential. A zero-knowledge proof is an interactive proof system between two parties, a prover (i.e., consumer) and a verifier (i.e., seller). The prover's goal is to convince the verifier through interaction that a statement is true. At the end of their interaction, the verifier is convinced that the statement is true, but does not learn any additional information beyond the validity of the statement. The present invention can leverage many of the available zero-knowledge proof techniques, such as those for comparison proof (e.g., Yao's millionaires protocol), proofs of knowledge (Schnorr protocol), proofs of knowledge of a discrete log representation of a number (Brands protocol), range proofs (Boudot protocol), and so on. For the discrete log representation of the credential above, the consumer can prove knowledge of x₁, x₂, . . . , xₙ to the seller, without disclosing their values to the seller. The consumer does this by computing a value known as a witness w=g^{w1}·g^{w2}· . . . ·g^{wn}, from n random elements wᵢ and sends w to the seller. The seller creates a challenge c and sends it to the consumer. The consumer responds by computing rᵢ=cxᵢ+wᵢ, for i=1, 2, . . . , n and sends these back to the seller. The seller can verify the proof with a simple check (is g₁^{r1}·g₂^{r2}· . . . ·gₙ^{rn} equal to w·h^{c}?). If so, the seller is convinced that the user knows x₁, x₂, . . . , xₙ, without the seller learning these values. Using zero-knowledge proof techniques, the consumer can prove compliance with some criteria, however the seller will not learn any information about what is encoded in the credential. Additionally, multi-show credentials, such as Carmenisch and Lysyanskaya, provide unlinkability, which prevents the seller from being able to link together multiple proofs involving the use of the same credential from a consumer.

As described above, the present invention provides a system and methods that preserve the privacy of personal information of consumers as they seek to take advantage of offers advertised by sellers or as they search for offers themselves. Even though the privacy of the personal information of a consumer is preserved, the provider of the offer (seller) is able to verify that the consumer meets some criteria without having to obtain personal information of the consumer other than that implied by the statement. The present invention considers an application where a requesting party (e.g., a seller) can advertise services or benefits (i.e., offers) with some criteria prospective consumers must satisfy to qualify for such services or benefits. A consumer can make a statement that shows that he or she satisfies the criteria. The requesting party is able to verify the correctness of the statement without being able to learn any additional information about the value of the attributes contained in the statement, other than the information directly implied by the statement. A consumer can be enrolled for the benefit or service after a statement has been successfully verified. Similarly, a consumer may create a statement involving some attribute and use the statement to search for offers. Sellers can evaluate the statement and potentially make offers without them learning any additional information about the values of the attributes.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for generating a verifiable statement comprising:
receiving, by a processing device, information about a consumer that is encrypted using searchable/predicate encryption;
receiving, by the processing device, a statement containing an attribute about the consumer that the consumer desires to have verified and a search token related to the attribute from a device operated by the consumer;
using, by the processing device, the search token to test the encrypted information to determine if the attribute is present in the encrypted information;
verifying, by the processing device, the attribute based on a positive result of the test using the search token and the encrypted information; and
providing, by the processing device, a digital signature for the statement to indicate that the statement is verified by the processing device.

2. The method of claim 1, further comprising:
sending, by the processing device, the signed statement to the consumer device.

3. The method of claim 3, further comprising:
using the signed statement to prove that the consumer meets some criteria related to the statement without having to reveal information about the consumer other than what is provided by the statement.

4. The method of claim 1, wherein the remote device operated by the consumer includes at least one of a personal computer, tablet, or smartphone.

5. A non-transitory computer readable medium comprising instructions, which when executed on a processing device, cause the processing device to use a search token received from a consumer device to test information that is encrypted using a searchable/predicate encryption function to determine if an attribute provided in a statement received from the consumer device is present in the encrypted information; verify the attribute based on a positive result of the test using the search token; and provide a digital signature for the statement to indicate that the statement is verified by the processing device.

6. A method for generating a verifiable credential for a consumer comprising:
receiving, by a processing device, information about the consumer that is encrypted using searchable/predicate encryption;
receiving, by the processing device, at least one statement having an attribute about the consumer that is to be contained in the credential and a search token related to the attribute from a device operated by the consumer;
using, by the processing device, the search token to test the encrypted information to determine if the attribute is present in the encrypted information;
encoding, by the processing device, the attributes for which a positive result of the test using the search token and the encrypted information is returned into a credential; and
providing, by the processing device, the credential to the device operated by the consumer.

7. The method of claim 6, further comprising:
storing the credential in the device operated by the consumer.

8. The method of claim 6, further comprising:
using the credential to engage in a zero-knowledge proof with a seller to prove the consumer complies with some criteria established by the seller.
